(19) United States
(12) Patent Application Publication
(10) Pub. No.: US 2023/0164635 A1
(43) Pub. Date: May 25, 2023

(54) METHOD FOR POINT-BASED SCHEDULING OF RADIO RESOURCES

(71) Applicant: Sterlite Technologies Limited, Gurugram (IN)

(72) Inventors: Nitin Kumar, Gurugram (IN); Manish Jamwal, Gurugram (IN); Rishi Kumar Nandwana, Gurugram (IN)

(73) Assignee: Sterlite Technologies Limited, Gurugram (IN)

(21) Appl. No.: 17/696,419

(22) Filed: Mar. 16, 2022

(30) Foreign Application Priority Data
Nov. 24, 2021 (IN) 202111054271

(51) Int. Cl. H04W 28/24; H04W 28/02; H04W 72/06; H04W 28/26

(52) U.S. Cl. CPC H04W 28/24; H04W 28/26; H04W 28/0268; H04W 72/06

(57) ABSTRACT

The present disclosure provides a method for scheduling one or more radio resources to a plurality of user equipment in a network. The method includes a first step of calculating an allocation factor for each of the plurality of user equipment. The method includes a second step of allocating one or more points to each of the plurality of user equipment. One or more points are allocated to each of the plurality of user equipment based on the service associated with each of the plurality of user equipment. The method includes a third step of calculating a rank for each of the plurality of user equipment. The method includes a fourth step of allocating one or more radio resources to each of the plurality of user equipment. One or more radio resources are allocated based on the rank of each of the plurality of user equipment.

### TECHNICAL FIELD

The present disclosure relates to the field of networking and allocation of network resources and, in particular, relates to the method for point-based scheduling of radio resources.

### BACKGROUND

Over the last few years, there is a rapid increase in the development of scheduling algorithms for allocating radio resources to multiple user equipment (UE). Conventionally, the implementation of a scheduler algorithm for allocation of resources to user equipment leads to many user’s equipments without radio resources. In addition, the conventional scheduler algorithms do not focus on the prioritization of UEs upon the quality of the channel. Also, implementation of the conventional scheduler algorithms leads to a dead state in radio communication where the user equipment has no resource for carrying information.

The prior art, US7046678 talks about a channel-efficiency based scheduling algorithm that can give network operators the flexibility of adjusting how resources are allocated among users with different link qualities and achieving the type of fairness and performance balance that they prefer. In a simple embodiment, the algorithm comprises the iterative steps of measuring channel quality for each user, calculating channel efficiency for each user and scheduling packets based on the channel efficiency values. Channel quality may be determined using conventional techniques such as determining signal power or signal to interference ratio or according to determining channel usage or effective serving rate metrics. Channel efficiency is the actual amount of data delivered to a user divided by the maximum amount of data that can be delivered with the same channel resource. Channel resources may, for example, include time slots in TDMA systems and their allocation via different modulation schemes. The system may select a higher bit rate, potentially more errored modulation scheme or a lower bit rate, more dependable packet data delivery scheme for transmission. Packet scheduling algorithms may comprise a variation on the weighted fair queueing algorithms, where an exponent is variably chosen depending on the channel efficiency considerations and numbers of users.

The prior art, US7245595 focuses on determining priorities of provided services for target terminals of cellular phones and ratios of the carrier signal to interference from multiple target terminals; and Based on the determined priorities, transmitting packet data to each the target terminal of cellular phones. In other words, the terminal selects which base station has the best channel quality and then let the selected base station know what the best channel quality is. This process is done through RCQICH (Reverse Common Quality Indicator Channel) to transmit the information back to the base station or sector. Therefore, only a base station that received the information of the link channel quality knows which terminal is selected. Then the base station starts to transmit data based on the received information of the link channel quality.

The prior art, US7027392 focuses on a method that includes receiving rate request indicators for a plurality of mobile stations, calculating priority function values for the plurality of mobile stations in response to the rate request indicators, and scheduling transmissions to the mobile stations according to the priority function value. According to another aspect, a wireless apparatus includes a priority factor calculation unit adapted to receive data rate requests from mobile stations and generate power factor values in response, and a scheduling unit coupled to the priority factor calculation unit, the scheduling unit adapted to schedule data transmissions.

All the above-mentioned prior arts are talking about particularly weight factor, throughput term, delay-based solution. Resources are allocated by the scheduler not in the combination or prioritization of devices upon the quality of the channel.

In light of the above stated discussion, there is a need for an efficient Point-based Scheduler Algorithm that overcomes the above stated disadvantages

### OBJECT OF THE DISCLOSURE

A primary object of the present disclosure is to provide a point-based scheduler that performs resource allocation to multiple user equipment based on priority calculation.

Another objective of the present disclosure is to provide a point-based scheduler that provides maximum throughput and avoids resource starvation.

### SUMMARY

In an aspect, the present disclosure provides a method for scheduling one or more radio resources to a plurality of user equipment in a network. The method includes a first step of calculating an allocation factor for each of the plurality of user equipment. The allocation factor is calculated based on the channel quality indicator. In addition, the method includes a second step of allocating one or more points to each of the plurality of user equipment. One or more points are allocated to each of the plurality of user equipment based on the service associated with each of the plurality of user equipment. Each service is associated with predefined points. The method includes a third step of calculating a rank for each of the plurality of user equipment. Further, the method includes a fourth step of allocating one or more radio resources to each of the plurality of user equipment. One or more radio resources are allocated based on the rank of each of the plurality of user equipment.

In an embodiment of the present disclosure, the method includes another step of allocating one or more guaranteed resources to the plurality of user equipment associated with a Guaranteed Bit Rate.

In an embodiment of the present disclosure, the allocation factor is based on a ratio of channel quality indicator and mean throughput of each of the plurality of user equipment.

In an embodiment of the present disclosure, calculation of the rank for each of the plurality of user equipment is performed by calculating one or more cumulative points based on the allocation factor and the one or more allocated points.

In an embodiment of the present disclosure, the method includes another step of calculating one or more delay budget points for each of the plurality of user equipment. In addition, the method includes yet another step of allocating one or more delay-budget points to each of the plurality of user equipment. Further, the method includes yet another step of calculating the rank for each of the plurality of user equipment based on the allocation factor, the one or more allocated points, and the one or more delay-budget points.

In an embodiment of the present disclosure, the method includes another step of allocating one or more subscriber-type points to each of the plurality of user equipment. In addition, the method includes yet another step of calculating the rank for each of the plurality of user equipment based on the allocation factor, the one or more allocated points and the one or more delay-budget points. Further, the method includes yet another step of prioritizing a plurality of users based on a type of data or services or one or more Quality of Services parameters. Furthermore, the method includes yet another step of calculating a factor value through the channel quality indicator and mean throughput for each Non-Guaranteed Bit Rate bearer. Every service is associated with a fixed default point to get the final factor value. Moreover, the method includes yet another step of allocating the highest rank to the highest factor value.

In an embodiment of the present disclosure, the method includes another step of calculating the rank for Non-Guaranteed Bit Rate bearer without service differentiation among the plurality of users. In addition, the method includes yet another step of calculating the rank for Non- Guaranteed Bit Rate bearer with service differentiation among the plurality of users.

In an embodiment of the present disclosure, the method includes slice-aware scheduling classification, calculation of rank is expressed as:

$$\text{FactorN} \text{=} \text{FactorM} \text{+} \text{PointD}$$

In an embodiment of the present disclosure, factor value calculation for Non- Guaranteed Bit Rate bearer with no service differentiation is expressed as:

$$\text{FactorW=} \left[\text{CQI*10}\right] / \left[\text{Mean Throughput}\right]$$

$$\text{FactorX} \text{=} \text{FactorW} \text{+} \text{PointS}$$

FactorX is the final factor value for resource allocation by rank calculation and Point S is the default 10 points for every service. CQI refers to channel quality indicator.

In an embodiment of the present disclosure, factor value calculation for Non- Guaranteed Bit Rate bearer with service differentiation is expressed as:

$$\text{Factor Y} \text{=} \text{Factor X} \text{+} \text{Point A}$$

Factor Y is the final factor value for resource allocation by rank calculation and Point A is the added points as per services given to the plurality of users.

In an embodiment of the present disclosure, factor value calculation for the one or more delay-budget points is expressed as:

$$\text{Factor Z} \text{=} \text{Factor Y} \text{+} \text{Point B}$$

Factor Z is the final factor value for resource allocation by rank calculation and Point B is the added points as per less time remaining for the one or more delay-budget points and Point B is defined by (ratio of time duration passed from last scheduling occasion/time duration of allowed maximum delay as per Guaranteed Bit Rate (GBR) service delay profile) *10000. Less time remaining of the one or more delay budget points add more points for getting a higher scheduler rank.

In an embodiment of the present disclosure, factor value calculation for prime users is expressed as:

$$\text{Factor M} \text{=} \text{Factor Z} \text{+} \text{Point C}$$

Factor M is the final factor value for resource allocation by rank calculation and Point C is added as per the profile of a plurality of users, wherein the plurality of users with high priority access is prioritized over other users.

In an embodiment of the present disclosure, factor value calculation for slice aware scheduling is expressed as:

$$\text{Factor N} \text{=} \text{Factor M} \text{+} \text{Point D}$$

Factor N is the final factor value for resource allocation by rank calculation and Point D is added as per the requirement of any slice, wherein the plurality of users with high priority slice is prioritized over other users.

In an embodiment of the present disclosure, the rank for each of a plurality of users defines the priority of resource allocation.

In an embodiment of the present disclosure, one or more points are configurable as per the profile of a plurality of users and the priority of each profile is considered through a ranking method.

In an embodiment of the present disclosure, the type of data or services includes at least one of conversational voice, live streaming of conversational voice, real-time gaming, video, and TCP-based applications.

In an embodiment of the present disclosure, the one or more Quality of Services parameters comprises throughput, latency, bandwidth, packet loss, transit delay, and priority.

In an embodiment of the present disclosure, a user of the plurality of users with the highest factor value is given high preference.

In an embodiment of the present disclosure, Guaranteed Bit Rate bearer has a guaranteed bit rate and Maximum Bit Rate, wherein Non-Guaranteed Bit Rate bearers may suffer packet loss under congestion, wherein Guaranteed Bit Rate bearers are immune to packet losses under congestion.

In an embodiment of the present disclosure, the one or more slice services comprises, ultra-reliable low-latency communication ( uRLLC ) and enhanced mobile broadband ( eMBB), where latency and reliability are major concerns for uRLLC applications, whereas eMBB services claim for the maximum data rates.

In an embodiment of the present disclosure, each of the plurality of user equipment is associated with a subscriber category, wherein the subscriber category or class comprises Gold, Bronze, and Prime etc.

In an embodiment of the present disclosure, any hybrid automatic repeat request gets 5000 points and Delta +100 points for each duration of the transmission is added.

In an embodiment of the present disclosure, 5G request gets 3000 points for Signalling Radio Bearer due to non-synchronous hybrid automatic repeat request, wherein Signalling Radio Bearer are signalling messages.

In an embodiment of the present disclosure, the priority order for logical channel multiplexing is set in a sequence of:
Signalling Radio Bearer 1;
Signalling Radio Bearer 2;
Guaranteed Bit Rate Bearer; and
Non-Guaranteed Bit Rate Bearer.

In an embodiment of the present disclosure, the highest rank is allocated to the highest factor based on the sum of the one or more allocated points for each service and the calculative allocation factor that is the ratio of channel quality indicator and mean throughput.

### STATEMENT OF THE DISCLOSURE

The present disclosure provides a method for scheduling one or more radio resources to a plurality of user equipment in a network. The method includes a first step of calculating an allocation factor for each of the plurality of user equipment. The allocation factor is calculated based on the channel quality indicator. In addition, the method includes a second step of allocating one or more points to each of the plurality of user equipment. One or more points are allocated to each of the plurality of user equipment based on the service associated with each of the plurality of user equipment. Each service is associated with predefined points. The method includes a third step of calculating a rank for each of the plurality of user equipment. Further, the method includes a fourth step of allocating one or more radio resources to each of the plurality of user equipment. One or more radio resources are allocated based on the rank of each of the plurality of user equipment.

### BRIEF DESCRIPTION OF FIGURES

Having thus described the disclosure in general terms, reference will now be made to the accompanying figures, wherein:

FIG. 1 illustrates a process flow chart depicting a method for scheduling one or more radio resources to a plurality of user equipment in a network using a point-based scheduler, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

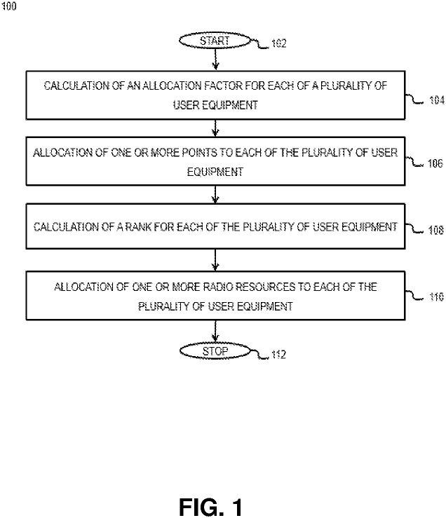

FIG. 1 illustrates a process flow chart 100 depicting a method for scheduling one or more radio resources to a plurality of user equipment in a network using a point-based scheduler, in accordance with the various embodiments of the present disclosure. The point-based scheduler allocates radio resources in any one of uplink or downlink to a plurality of users to access a type of data or services using point-based scheduling. In general, scheduling is an action of assigning resources to a communication device of the user or user equipment to perform a set of tasks. In an embodiment of the present disclosure, the point-based scheduler provides maximum throughput (the total amount of work completed per time unit) and minimizes wait time (time from work becoming ready until the first point it begins execution).

The process flowchart 100 initiates at step 102. Following step 102, at step 104, the method includes the calculation of an allocation factor for each of the plurality of user equipment. The allocation factor is calculated based on the channel quality indicator (CQI). The allocation factor is based on a ratio of channel quality indicator and mean throughput of each of the plurality of user equipment. In an embodiment of the present disclosure, the plurality of user equipment includes but may not be limited to smartphones, computers, laptops, tablets, and palmtops. The plurality of user equipment belongs to the plurality of users. In an embodiment of the present disclosure, the plurality of users are the owners of the plurality of user equipment. Each of the plurality of user equipment is associated with a subscriber category. The subscriber category or class includes but may not be limited to Gold, Bronze, and Prime.

At step 106, the method includes the allocation of one or more points to each of the plurality of user equipment using the point-based scheduler. One or more points are allocated to each of the plurality of user equipment based on a type of data or services associated with each of the plurality of user equipment. Each service is associated with predefined points. In an embodiment of the present disclosure, the type of data or services includes conversational voice, live streaming of conversational voice, real-time gaming, video, TCP-based applications and the like. One or more points are configurable as per the profile of the plurality of users and the priority of each profile is considered through a ranking method.

At step 108, the method includes the calculation of a rank for each of the plurality of user equipment using the point-based scheduler. The rank for each of the plurality of user equipment is calculated based on the allocation factor and the one or more allocated points. In addition, the point-based scheduler performs a calculation of the rank for each of the plurality of user equipment is performed by calculating one or more cumulative points based on the allocation factor and the one or more allocated points. The method for calculation of the rank for each of the plurality of user equipment includes calculating the rank for Non-Guaranteed Bit Rate bearer without service differentiation among the plurality of users. In addition, the method for calculation of the rank for each of the plurality of user equipment includes calculating the rank for Non- Guaranteed Bit Rate bearer with service differentiation among the plurality of users. The rank for each of the plurality of users/plurality of user equipment defines the priority of resource allocation.

In an embodiment of the present disclosure, the method includes the calculation of one or more delay budget points for each of the plurality of user equipment. In addition, the method includes the allocation of one or more delay-budget points to each of the plurality of user equipment. Further, the method includes calculation of the rank for each of the plurality of user equipment based on the allocation factor, the one or more allocated points, and the one or more delay-budget points.

In an embodiment of the present disclosure, the method includes the allocation of one or more subscriber-type points to each of the plurality of user equipment. In addition, the method includes calculation of the rank for each of the plurality of user equipment based on the allocation factor, the one or more allocated points and the one or more delay-budget points. Further, the method includes prioritization of the plurality of users of the plurality of user equipment based on the type of data or services or one or more Quality of Services parameters. The one or more Quality of Services parameters include but may not be limited to throughput, latency, bandwidth, packet loss, transit delay, and priority. Furthermore, the method includes the calculation of a factor value through the channel quality indicator and mean throughput for each Non-Guaranteed Bit Rate bearer. Every service is associated with a fixed default point to get the final factor value. Moreover, the method includes the allocation of the highest rank to the highest factor value. In an embodiment of the present disclosure, a user of the plurality of user equipment with the highest factor value is given high preference.

In another embodiment of the present disclosure, the method includes the slice aware scheduling, one or more slice-type points added to each of the plurality of user equipment. In addition, the method includes calculation of the rank for each of the plurality of user equipment based on the allocation factor, the one or more allocated points and the one or more types of the slice. Further, the method includes prioritization of the plurality of users of the plurality of user equipment based on the type of slicing services. The one or more network slice types include eMBB (enhanced Mobile Broadband), which is an extension of the 4G mobile broadband service; URLLC (Ultra-Reliable Low Latency Communications), which provides low-latency and reliable communication; and mMTC (massive Machine Type Communications), which supports massive IoT devices with narrow bandwidth requirements. Furthermore, the method includes the calculation of a factor value through the channel quality indicator and mean throughput for each Non-Guaranteed Bit Rate bearer. Every service is associated with a fixed default point to get the final factor value. Moreover, the method includes the allocation of the highest rank to the highest factor value. In an embodiment of the present disclosure, a user of the plurality of user equipment with the highest factor value is given high preference.

At step 110, the method includes the allocation of one or more radio resources to each of the plurality of user equipment. One or more radio resources are allocated to each of the plurality of user equipment based on the rank of each of the plurality of user equipment. The process flowchart 100 terminates at step 112.

The point-based scheduler allocates one or more points to the plurality of user equipment. The point-based scheduler allocates one or more guaranteed resources to the plurality of user equipment associated with a Guaranteed Bit Rate. Any hybrid automatic repeat request gets 5000 points and Delta +100 points for each duration of transmission are added by the point-based scheduler. Any SRB gets 3000 points and Delta +100 points for each duration of new transmission are added. Signalling Radio Bearer is signalling messages.

The point-based scheduler allocates one or more radio resources to the plurality of user equipment based on the highest priority rank calculation to one or more cases. One or more cases include Non- Guaranteed Bit Rate (GBR) classification, Guaranteed Bit Rate (GBR) classification, prime users classification, subscription or slice-aware scheduling classification.

Non-Guaranteed Bit Rate bearers may suffer packet loss under congestion. Non-Guaranteed Bit Rate classification is divided into a first case and a second case. The first case corresponds to factor value calculation for Non-Guaranteed Bit Rate bearer with no service differentiation. The second case corresponds to factor value calculation for Non- Guaranteed Bit Rate bearer with service differentiation.

The point based scheduler performs factor value calculation for Non-Guaranteed Bit Rate bearers with no service differentiation. In addition, factor value calculation for Non-Guaranteed Bit Rate bearer is expressed as:

$$\text{Factor W=} \left[\text{CQI*10}\right] / \left[\text{Mean Throughput}\right]$$

$$\text{Factor X} \text{=} \text{Factor W} \text{+} \text{Point S}$$

Where Factor X is the final factor value for resource allocation by rank calculation and Point S is the default 10 points for every service, and CQI refers to channel quality indicator.

The point based scheduler performs factor value calculation for Non-Guaranteed Bit Rate bearer with service differentiation. In addition, factor value calculation for Non-Guaranteed Bit Rate bearer is expressed as:

$$\text{Factor Y} \text{=} \text{Factor X} \text{+} \text{Point A}$$

where Factor Y is the final factor value for resource allocation by rank calculation and Point A is the added points as per services given to the plurality of users.

Further, Guaranteed Bit Rate bearer has a guaranteed bit rate and Maximum Bit Rate. Guaranteed Bit Rate bearers are immune to packet losses under congestion. Furthermore, Guaranteed Bit Rate (GBR) classification includes factor value calculation for one or more delay points. The calculation of factor value for the one or more delay points is expressed as:

$$\text{Factor Z} \text{=} \text{Factor Y} \text{+} \text{Point B}$$

Where Factor Z is the final factor value for resource allocation by rank calculation and Point B is the added points as per less time remaining for the one or more delay-budget points and Point B is defined by (ratio of time duration passed from last scheduling occasion/time duration of allowed maximum delay as per Guaranteed Bit Rate (GBR) service delay profile) *10000. Less time remaining of the one or more delay budget points add more points for getting a higher scheduler rank.

Further, prime users classification includes factor value calculation for prime users of the plurality of users. The calculation of factor value for prime users is expressed as:

$$\text{Factor M} \text{=} \text{Factor Z} \text{+} \text{Point C}$$

Factor M is the final factor value for resource allocation by rank calculation and Point C is added as per the profile of the plurality of users. The plurality of users with the highest priority access are prioritized over other users.

Furthermore, slice aware scheduling includes the addition of an extra slice on the requirement of any slice. The calculation of factor value for slice aware scheduling is expressed as:

$$\text{Factor N} \text{=} \text{Factor M} \text{+} \text{Point D}$$

Factor N is the final factor value for resource allocation by rank calculation and Point D is a fixed point, which is added as per the requirement of any slice. The plurality of users with the highest priority slice is prioritized over other normal users.

The priority order for logical channel multiplexing is set in a sequence of Signalling Radio Bearer 1, Signalling Radio Bearer 2, Guaranteed Bit Rate Bearer and Non-Guaranteed Bit Rate Bearer. In addition, the priority order may be expressed as:

$$\begin{matrix}\text{Signalling Radio Bearer 1> Signalling Radio Bearer 2> Guaranteed Bit Rate} \\ \text{Bearer > Non-Guaranteed Bit Rate Bearer}\end{matrix}$$

The highest rank is allocated to the highest factor based on the sum of one or more allocated points for each service and the calculative allocation factor that is the ratio of channel quality indicator and mean throughput.

In an example, the point-based scheduler performs downlink scheduling in a case of a Non-Guaranteed bit rate with no service differentiation. A first user equipment has mean throughput of 9.4 mbps, a channel quality indicator (CQI) of 15 and a factor X of 15.96. The rank comes is calculates as 5. A second user equipment has mean throughput of 6.4 mbps, a channel quality indicator of 13 and factor X of 20.31, and the rank is calculated as 2. A third user equipment has mean throughput of 5.4 mbps, a channel quality indicator of 10 and factor X of 18.52, and the rank is calculated as 4. User Equipment with higher CQI is given preference. The rank is calculated as:

$$\text{Factor W=} \left[\text{CQI*10}\right] / \left[\text{Mean Throughput}\right]$$

$$\text{Factor X} \text{=} \text{Factor W} \text{+} \text{Point S}$$

The user equipment with the highest rank (first user equipment) is given to the highest Factor X. Every Service has 10 points by default. (Point S)

In another example, the point-based scheduler performs downlink scheduling in the case of Non-Guaranteed bit rate with service differentiation. A user equipment UE1 has mean throughput of 9.4 mbps, channel quality indicator of 15, factor X of 15.96, point A of 150, factor Y of 165. 96, and the rank of 2. A user equipment UE2 has mean throughput of 6.4 mbps, a channel quality indicator of 13, factor X of 20.31, point A of 100, factor Y of 120.31, and the rank of 3. A user equipment UE3 has mean throughput of 5.4 mbps, a channel quality indicator of 10, factor X of 18.52, point A of 100, factor Y of 118.52, and the rank of 4. User Equipment with higher CQI is given preference. The rank is calculated as:

$$\text{Factor X=} \left[\text{CQI*10}\right] / \left[\text{Mean Throughput}\right]$$

Each Service has a specific Point added (Point A). The highest rank is given to the highest Factor Y. Factor Y = Factor X + Point A.

In an example, 2 UEs have a delay budget of 20 ms. The current Delay of UE-1 is 5 ms and UE-2 is 15 ms. UE-1 will get points (point B) as [5/20] * 10000 = 250 and UE-2 will get points (point B) as [15/20] * 10000 = 750. The rank will be as per Factor Z= Factor Y + point B. More points (point B) are added as per the delay budget. Less time remaining of delay budget will add more points for getting a higher scheduler rank.

In another example, two UEs (UE-a and UE-b) have a GOLD subscription, the rest have a normal subscription. Current 800 points are added for UE-a and UE-b. The rank will be as per FactorM= FactorZ + pointC. More points (point C) are added as per the user profile. Users with high priority access will be prioritized over normal users.

In another example, two UEs (UE-a and UE-b) are using high priority slices. Current 1200 points are added for UE-a and UE-b. The rank will be as per FactorN= FactorM + pointD. More points (point D) are added as per the Network slice selection function component with the particular purpose of slice selection. Users with high priority access will be prioritized over normal users.

In an example, the point-based scheduler allocates virtual resources to Primary Synchronization Signal (PSS) / Physical Control Format Indicator Channel (PCFICH) / Paging Control Channel (PCCH) / Broadcast Control Channel (BCCH) and the like. The point-based scheduler takes input from the physical layer and analyses remaining resources after allocation. Further, the point-based scheduler selects one or more schedulable user equipment (UE) by evaluating the users which can be scheduled with a set of parameters. The set of parameters include but may not be limited to: data in buffer for the user equipment, UE has a valid available CQI, UE should be in inactive DRX state, and measurement gap shouldn’t be active for UE. The point-based scheduler creates a list of selected users, List-1. The point-based scheduler prioritises users from List-1 using “Point-based” time-domain scheduling. The point-based scheduler discards non-scheduled UEs. The point-based scheduler generates List-2 with the remaining UEs. Furthermore, the point-based scheduler performs frequency domain scheduling. In frequency domain scheduling, the point-based scheduler considers/takes UEs in priority order from List-2 and take channel quality report from link adaption entity for all UEs. Moreover, the point-based scheduler allocates physical resource blocks from the best suitable location in the frequency domain in priority order.

Also, the point-based scheduler performs logical channel multiplexing by prioritizing Signalling Radio Bearer -1 and then Signalling Radio Bearer-2. The point-based scheduler performs logical channel multiplexing by prioritizing DRB in priority order of logical channel priority and scheduling priority. Also, the point-based scheduler allocates Allocate CCE/PDCCH for downlink/uplink together and updates DCI.

The plurality of user equipment may have multiple logical channels to be transmitted through the same transport block. Each logical channel has priority where an increasing priority value indicates a lower priority level, prioritisedBitRate which sets the Prioritized Bit Rate (PBR), bucketSizeDuration which sets the Bucket Size Duration (BSD). Priority will be according to the below order: SRB1>SRB2>DRB(GBR)>DRB(Non-GBR).

The basic idea for each logical channel j a variable B j is defined:
B ⱼ (0) = 0, when the logical channel is established.
B ⱼ (t) = min { B ⱼ (t-1) + PBR ⱼ * 1 ms, PBR ⱼ * BSD ⱼ } [bits]
B ⱼ (t), is decremented in each transmission by the amount of MAC SDU number of bits filled by the logical channel j into the transport block and increased if the logical channel is not scheduled in this transmission.

The point-based scheduler allocates one or more radio resources to the plurality of user equipment using one of the first approaches, a second approach and the third approach. The first approach corresponds to the maximum channel quality indicator (CQI) approach. The users with the highest or maximum CQI will be provided resources. The second approach corresponds to the Round-robin approach. In the Round-robin approach, all users from the list will get resources as per sequence order. The third approach corresponds to the Proportional Fair approach. The proportional Fair approach is a combination of the first approach and the second approach. Higher CQI UEs will be prioritized, but lower CQI UEs also get resources.

The present invention talks about the point-based scheduler that has various advantages over the prior arts. The point-based scheduler is a slice aware scheduler that follows the basic slicing concept. The point-based scheduler is lightweight and easy to implement. The point-based scheduler enhances the cell capacity (throughput). The point-based scheduler prioritizes higher CQI UEs, but lower CQI UEs also get the resource. Users with high priority access will be prioritized over normal users. Also, the point-based scheduler avoids resource starvation.

The foregoing descriptions of specific embodiments of the present technology have been presented for purposes of illustration and description. They are not intended to be exhaustive or to limit the present technology to the precise forms disclosed, and many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A method for scheduling one or more radio resources to a plurality of user equipment in a network, the method comprising:
calculating, at a point-based scheduler, an allocation factor for each of the plurality of user equipment, wherein the allocation factor is calculated based on channel quality indicator;
allocating, at the point-based scheduler, one or more points to each of the plurality of user equipment, wherein the one or more points are allocated to each of the plurality of user equipment based on a type of data, services, subscription or slice associated with each of the plurality of user equipment, wherein each service is associated with predefined points;
calculating, at the point-based scheduler, a rank for each of the plurality of user equipment; and
allocating, at the point-based scheduler, the one or more radio resources to each of the plurality of user equipment, wherein the one or more radio resources are allocated based on the rank of each of the plurality of user equipment.

2. The method as claimed in claim 1, wherein the rank for each of the plurality of user equipment is calculated based on the allocation factor and the one or more allocated points.

3. The method as claimed in claim 1, further comprising allocating one or more guaranteed resources to the plurality of user equipment associated with a Guaranteed Bit Rate.

4. The method as claimed in claim 1, wherein the allocation factor is based on a ratio of channel quality indicator and mean throughput of each of the plurality of user equipment.

5. The method as claimed in claim 1, wherein the calculation of the rank for each of the plurality of user equipment is performed by calculating one or more cumulative points based on the allocation factor and the one or more allocated points.

6. The method as claimed in claim 1, further comprising:
a. calculating one or more delay budget points for each of the plurality of user equipment;
b. allocating the one or more delay-budget points to each of the plurality of user equipment; and
c. calculating the rank for each of the plurality of user equipment based on the allocation factor, the one or more allocated points, and the one or more delay-budget points and points added as per the requirement of the slice.

7. The method as claimed in claim 1, further comprising:
a. allocating one or more subscriber-type points to each of the plurality of user equipment;
b. calculating the rank for each of the plurality of user equipment based on the allocation factor, the one or more allocated points, the one or more delay-budget points and also points added as per the requirement of the slice;
c. prioritizing a plurality of users based on the type of data or services or one or more Quality of Services parameters;
d. calculating factor value through the channel quality indicator and mean throughput for each Non-Guaranteed Bit Rate bearer; wherein every service is associated with a fixed default point to get final factor value; and
e. allocating the highest rank to the highest factor value.

8. The method as claimed in claim 1, further comprising:
a. calculating the rank for Non- Guaranteed Bit Rate bearer without service differentiation among a plurality of users; and
b. calculating the rank for Non- Guaranteed Bit Rate bearer with service differentiation among the plurality of users.

9. The method as claimed in claim 8, wherein factor value calculation for Non-Guaranteed Bit Rate bearer with no service differentiation is expressed as:
$$\text{FactorW} = \left[\text{CQI*10}\right] / \left[\text{Mean Throughput}\right]$$
$$\text{FactorX} = \text{FactorW} + \text{PointS}$$
wherein FactorX is the final factor value for resource allocation by rank calculation and Point S is the default 10 points for every service, wherein CQI refers to channel quality indicator.

10. The method as claimed in claim 8, wherein factor value calculation for Non-Guaranteed Bit Rate bearer with service differentiation is expressed as:
$$\text{Factor Y} = \text{Factor X} + \text{Point A}$$
wherein Factor Y is the final factor value for resource allocation by rank calculation and Point A is the added points as per services given to the plurality of users.

11. The method as claimed in claim 6, wherein factor value calculation for the one or more delay-budget points is expressed as:
$$\text{Factor Z} = \text{Factor Y} + \text{Point B}$$
wherein Factor Z is the final factor value for resource allocation by rank calculation and PointB is defined by the ratio of (time duration passed from last scheduling occasion/time duration of allowed maximum delay as per GBR service delay profile) * 10000, wherein less time remaining of the one or more delay budget points add more points for getting higher scheduler rank.

12. The method as claimed in claim 7, wherein factor value calculation for prime users is expressed as:
$$\text{Factor M} = \text{Factor Z} + \text{Point C}$$
wherein Factor M is the final factor value for resource allocation by rank calculation and Point C is added as per the profile of a plurality of users, wherein the plurality of users with high priority access are prioritized over other users.

13. The method as claimed in claim 7, wherein factor value calculation for slice aware scheduling is expressed as:
$$\text{Factor N} = \text{Factor M} + \text{Point D}$$
wherein Factor N is the final factor value for resource allocation by rank calculation and Point D is fixed points added to the plurality of users using high priority slice, wherein the plurality of users with high priority access are prioritized over other users.

14. The method as claimed in claim 1, wherein the rank for each of a plurality of users defines the priority of resource allocation.

15. The method as claimed in claim 1, wherein the one or more points are configurable as per the profile of a plurality of users and priority of each profile is considered through a ranking method.

16. The method as claimed in claim 1, wherein the type of data or services comprises at least one of conversational voice, live streaming of conversational voice, real-time gaming, video, and TCP-based applications etc.

17. The method as claimed in claim 7, wherein the one or more Quality of Services parameters comprises throughput, latency, bandwidth, packet loss, transit delay, and priority.

18. The method as claimed in claim 7, wherein a user of the plurality of users with the highest factor value is given high preference.

19. The method as claimed in claim 1, wherein Guaranteed Bit Rate bearer has a guaranteed bit rate and Maximum Bit Rate, wherein Non-Guaranteed Bit Rate bearers may suffer packet loss under congestion, wherein Guaranteed Bit Rate bearers are immune to packet losses under congestion.

20. The method as claimed in claim 1, wherein each of the plurality of user equipment is associated with a subscriber category, wherein the subscriber category comprises Gold, Bronze, and Prime or more other similar terminologies to differentiate subscriber category or class.

21. The method as claimed in claim 1, wherein any hybrid automatic repeat request gets 3000 points and Delta +100 points for each duration of new transmission are added.

22. The method as claimed in claim 1, wherein any SRB gets 3000 points and Delta +100 points for each duration of new transmission are added.

23. The method according to claim 7, wherein the highest rank is allocated to the highest factor based on the sum of the one or more allocated points for each service and the calculative allocation factor that is the ratio of channel quality indicator and mean throughput.
